(19) United States
(12) Patent Application Publication
(10) Pub. No.: US 2025/0184768 A1
(43) Pub. Date: Jun. 5, 2025

(54) MONITORING METHOD AND APPARATUS OF AI/ML MODEL

(71) Applicant: FUJITSU LIMITED, Kawasaki-shi (JP)

(72) Inventors: Xin WANG, Beijing (CN); Gang SUN, Beijing (CN); Qun ZHANG, Beijing (CN); Jian ZHANG, Beijing (CN)

(73) Assignee: FUJITSU LIMITED, Kawasaki-shi (JP)

(21) Appl. No.: 19/023,997

(22) Filed: Jan. 16, 2025

Related U.S. Application Data
(63) Continuation of application No. PCT/CN2022/112284, filed on Aug. 12, 2022.

(51) Int. Cl. H04W 24/02; H04B 7/06; H04W 24/10; H04W 72/1268

(52) U.S. Cl. CPC H04W 24/02; H04B 7/0626; H04W 24/10; H04W 72/1268

(57) ABSTRACT

A monitoring apparatus of an AI/ML model includes: a receiver configured to receive an uplink reference signal transmitted by a terminal equipment; and processor circuitry configured to perform performance monitoring on the AI/ML model by using the uplink reference signal.

### CROSS-REFERENCE TO RELATED APPLICATION

This application is a continuation application of International Application PCT/CN2022/112284 filed on Aug. 12, 2022, and designated the U.S., the entire contents of which are incorporated herein by reference.

### TECHNICAL FIELD

Embodiments of the present disclosure relate to the technical field of communication.

### BACKGROUND

Multi-antenna technology has been widely applied in LTE, LTE-A and 5G NR systems. In particular, massive antenna technology (massive MIMO) is supported very well in the 5G Standard. It may be predicted that in 5G-Advanced stage and 6G stage, the massive MIMO technology will be more widely used, massive and ultra-massive antenna technologies with enhanced performance are also research focuses of a next generation mobile communication system.

With development of artificial intelligence (AI) and machine learning (ML) technologies, applying AI/ML technologies to wireless communication becomes a current technical direction, so as to solve the difficulties of traditional methods. Applying an AI/ML model to a wireless communication system, particularly to transmission of an air interface, is a new technology in 5G-Advanced and 6G stages.

For example, for measurement and feedback of channel state information (CSI), CSI is measured at a terminal equipment side, an AI/ML model is used to generate CSI feedback information, and after transmitting the same to a network side via an air interface, the network side receives the CSI feedback information, and restores original CSI via a corresponding AI/ML model. In such example, through the AI/ML model, CSI feedback overhead may be reduced, or the quality of feedbacks may be improved, thereby improving communication quality.

For another example, applying an AI/ML technology in beam management may improve beam management quality, speed up a beam scanning speed, and reduce or avoid occurrence of a beam failure. Applying the AI/ML technology in a positioning technology may improve accuracy of positioning. Other applications, such as channel estimation, beamforming, mobility management, modulation and demodulation, may use AI/ML to improve performance and reduce overhead, and bring gains in terms of improving reliability and reducing latency, etc.

It should be noted that the above introduction to the technical background is just to facilitate a clear and complete description of the technical solutions of the present disclosure, and is elaborated to facilitate understanding of persons skilled in the art. It cannot be considered that these technical solutions are known by persons skilled in the art just because these solutions are elaborated in the Background of the present disclosure.

### SUMMARY

However, the inventor finds that an AI/ML model may experience performance degradation, the performance needs to be monitored. However, currently, there is no solution for how to specifically monitor and which parameters are used for monitoring.

For at least one of the above problems, the embodiments of the present disclosure provide a monitoring method and apparatus of an AI/ML model.

According to one aspect of the embodiments of the present disclosure, a monitoring method of an AI/ML model is provided in which the performance of the AI/ML model is monitored by a network device, and the method includes:
the network device receives an uplink reference signal transmitted by a terminal equipment; and
the network device performs performance monitoring on the AI/ML model by using the uplink reference signal.

According to another aspect of the embodiments of the present disclosure, a monitoring apparatus of an AI/ML model is provided, including:
a receiving unit configured to receive an uplink reference signal transmitted by a terminal equipment; and
a monitoring unit configured to perform performance monitoring on the AI/ML model by using the uplink reference signal.

According to a further aspect of the embodiments of the present disclosure, a monitoring method of an AI/ML model is provided in which the performance of the AI/ML model is monitored by a terminal equipment, and the method includes:
the terminal equipment receives a downlink reference signal transmitted by a network device; and
the terminal equipment performs performance monitoring on the AI/ML model by using the downlink reference signal.

According to another aspect of the embodiments of the present disclosure, a monitoring apparatus of an AI/ML model is provided, the apparatus including:
a receiving unit configured to receive a downlink reference signal transmitted by a network device; and
a monitoring unit configured to perform performance monitoring on the AI/ML model by using the downlink reference signal.

According to a further aspect of the embodiments of the present disclosure, a communication system is provided, including:
a terminal equipment configured to receive a downlink reference signal transmitted by a network device, and perform performance monitoring on the AI/ML model by using the downlink reference signal; and/or
the network device configured to receive an uplink reference signal transmitted by the terminal equipment, and perform performance monitoring on the AI/ML model by using the uplink reference signal.

One of advantageous effects of the embodiments of the present disclosure includes: the network device receives an uplink reference signal transmitted by the terminal equipment, and the network device performs performance monitoring on the AI/ML model by using the uplink reference signal. Thereby, suitable label data may be obtained at a smaller cost to support monitoring of the AI/ML model.

Referring to the later description and drawings, specific implementations of the present disclosure are disclosed in detail, indicating a mode that the principle of the present disclosure may be adopted. It should be understood that the implementations of the present disclosure are not limited in terms of a scope. Within the scope of the spirit and terms of the attached claims, the implementations of the present disclosure include many changes, modifications and equivalents.

Features that are described and/or shown for one implementation may be used in the same way or in a similar way in one or more other implementations, may be combined with or replace features in the other implementations.

It should be emphasized that the term “comprise/include” when being used herein refers to presence of a feature, a whole piece, a step or a component, but does not exclude presence or addition of one or more other features, whole pieces, steps or components.

### BRIEF DESCRIPTION OF DRAWINGS

An element and a feature described in a drawing or an implementation of the embodiments of the present disclosure may be combined with an element and a feature shown in one or more other drawings or implementations. In addition, in the drawings, similar labels represent corresponding components in several drawings and may be used to indicate corresponding components used in more than one implementation.

FIG. 1 is a schematic diagram of a communication system in embodiments of the present disclosure;

FIG. 2 is a schematic diagram of a monitoring method of an AI/ML model in embodiments of the present disclosure;

FIG. 3 is a schematic diagram of an AI/ML model in embodiments of the present disclosure;

FIG. 4 is an example diagram of monitoring by a network device in embodiments of the present disclosure;

FIG. 5 is a schematic diagram of antenna port switching in embodiments of the present disclosure;

FIG. 6 is an example diagram of signal extraction in embodiments of the present disclosure;

FIG. 7 is an example diagram of signaling for monitoring an AI/ML model in embodiments of the present disclosure;

FIG. 8 is an example diagram of a reference signal in embodiments of the present disclosure;

FIG. 9 is a schematic diagram of a two-sided model applied in a gNB and a UE in embodiments of the present disclosure;

FIG. 10 is a schematic diagram of a model applied in a gNB in embodiments of the present disclosure;

FIG. 11 is a schematic diagram of a monitoring method of an AI/ML model in embodiments of the present disclosure;

FIG. 12 is an example diagram of signaling for monitoring an AI/ML model in embodiments of the present disclosure;

FIG. 13 is another example diagram of signaling for monitoring an AI/ML model in embodiments of the present disclosure;

FIG. 14 is an example diagram of performing model training by a terminal equipment in embodiments of the present disclosure;

FIG. 15 is a schematic diagram of a model applied in a UE in embodiments of the present disclosure;

FIG. 16 is a schematic diagram of a monitoring apparatus of an AI/ML model in embodiments of the present disclosure;

FIG. 17 is a schematic diagram of a monitoring apparatus of an AI/ML model in embodiments of the present disclosure;

FIG. 18 is a schematic diagram of a network device in embodiments of the present disclosure;

FIG. 19 is a schematic diagram of a terminal equipment in embodiments of the present disclosure.

### DETAILED DESCRIPTION

Referring to the drawings, through the following Specification, the aforementioned and other features of the present disclosure will become obvious. The Specification and the drawings specifically disclose particular implementations of the present disclosure, showing partial implementations which may adopt the principle of the present disclosure. It should be understood that the present disclosure is not limited to the described implementations, on the contrary, the present disclosure includes all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

In the embodiments of the present disclosure, the term “a communication network” or “a wireless communication network” may refer to a network that meets any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be carried out according to a communication protocol at any stage, for example may include but be not limited to the following communication protocols: 1G (generation), 2G, 2.5G, 2.75G, 3G, 4G, 4.5G, and 5G, New Radio (NR), future 6G and so on, and/or other communication protocols that are currently known or will be developed in the future.

In the embodiments of the present disclosure, the term “a network device” refers to, for example, a device that accesses a terminal equipment in a communication system to a communication network and provides services to the terminal equipment. The network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

The base station may include but be not limited to: a node B (NodeB or NB), an evolution node B (eNodeB or eNB), a 5G base station (gNB) and an IAB donor, etc., and may further includes a Remote Radio Head (RRH), a Remote Radio Unit (RRU), a relay or a low power node (such as femeto, pico, etc.). And the term “base station” may include their some or all functions, each base station may provide communication coverage to a specific geographic region. The term “cell” may refer to a BS and/or its coverage area, which depends on the context in which this term is used.

In the embodiments of the present disclosure, the term “User Equipment (UE)” or “Terminal Equipment (TE) or Terminal Device” refers to, for example, a device that accesses a communication network and receives network services through a network device. The terminal equipment may be fixed or mobile, and may also be referred to as Mobile Station (MS), a terminal, Subscriber Station (SS), Access Terminal (AT) and a station and so on.

The terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), the terminal equipment may also be a machine or apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, the term “a network side” or “a network device side” refers to a side of a network, may be a base station, and may include one or more network devices as described above. The term “a user side” or “a terminal side” or “a terminal equipment side” refers to a side of a user or terminal, may be a UE, and may include one or more terminal equipment as described above. If it is not specifically mentioned herein, “a device” may refer to a network device, or may refer to a terminal equipment.

Scenarios of the embodiments of the present disclosure are described through the following examples, however the present disclosure is not limited to these.

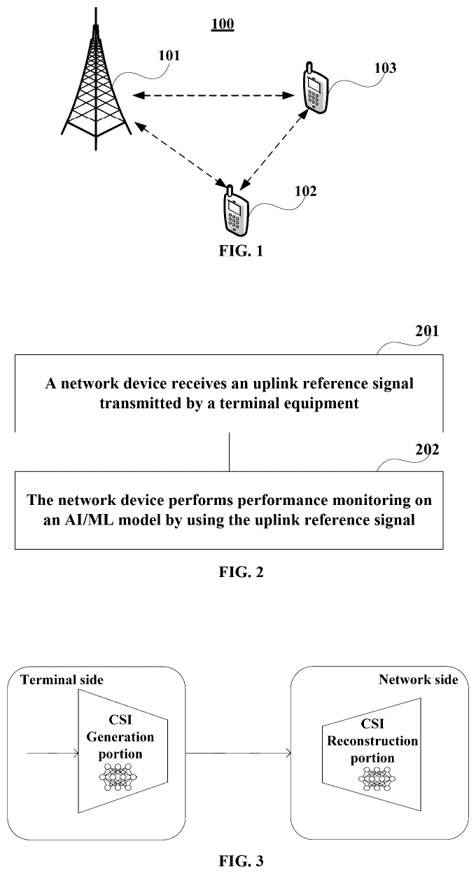

FIG. 1 is a schematic diagram of a communication system in the embodiments of the present disclosure, schematically describes situations by taking a terminal equipment and a network device as examples. As shown in FIG. 1, a communication system 100 may include a network device 101 and terminal equipment 102, 103. For simplicity, FIG. 1 only takes two terminal equipment and one network device as examples for description, however the embodiments of the present disclosure are not limited to this.

In the embodiments of the present disclosure, transmission of existing or further implementable services may be carried out between the network device 101 and the terminal equipment 102, 103. For example, these services may include but be not limited to: enhanced Mobile Broadband (eMBB), massive Machine Type Communication (mMTC), Ultra-Reliable and Low-Latency Communication (URLLC) and so on.

It is worth noting that FIG. 1 shows that two terminal equipment 102 and 103 are within the coverage of network device 101, but the present disclosure is not limited to this. The two terminal equipment 102 and 103 may be outside the coverage of the network device 101, or one terminal equipment 102 may be within the coverage of the network device 101 and the other terminal equipment 103 may be outside the coverage of the network device 101.

In the embodiments of the present disclosure, higher layer signaling may be e.g. radio resource control (RRC) signaling; for example, is called an RRC message, for example includes an MIB, system information, and a dedicated RRC message; or is called an RRC information element (RRC IE). The higher layer signaling, for example, may further be Medium Access Control (MAC) signaling; or called a MAC control element (MAC CE). However, the present disclosure is not limited to this.

In the embodiments of the present disclosure, one or more AI/ML models may be configured and run in a network device and/or a terminal equipment. The AI/ML model may be used for various signal processing functions of wireless communication, such as CSI estimation and reporting, beam management and beam prediction, etc.; the present disclosure is not limited to this.

Although the application of AI/ML may bring performance gains, unlike traditional modes based on a communication theory and a signal processing theory, its performance depends largely on a data set for training, and data that needs to be processed in its application scenarios.

For example, a situation that happens very easily is that data statistical characteristics of the data set for training are inconsistent with data characteristics of an environment in which it is applied. Especially for various radio environments as well as radio frequency and antenna devices used at both transmitting side and receiving side, these factors may be summarized as radio equivalent channels between a network device and a terminal equipment. Diversity of radio channels makes it difficult for radio channel data for training to traverse all channels when a neural network model is constructed. Therefore, when the model is used in an actual radio environment, radio channels applied by it are generally not encountered in its training process.

Especially for mobile communication, a model at a terminal side will experience various environments as it moves, such as urban, suburban, an environment in which tall buildings are dense, an environment in which road networks are interwoven, various indoor environments, various movement speeds, etc., all of which may cause a model mismatch problem. The so-called model mismatch refers to inconsistency of statistical characteristics between data used in the construction of a model and data processed when it is applied, such inconsistency may lead to degradation of the performance of the model, even the performance degrades not as good as traditional signal processing methods, or even to be an unacceptable degree.

To deal with this problem, it is necessary to perform performance monitoring on the model, and switch to a traditional signal processing method when determining that there is an issue in model performance. In addition, in an application environment, the model is constantly retrained or fine tuned based on radio data of the environment, so as to constantly optimize network parameters and even a structure, and replace an existing AI/ML model at an appropriate moment.

All of these operations require a reference signal or reference data, which may be called ground truth label, or called label data or label signal for short, or in some occasions, called meta data or signal. Its use is that for certain input data of a model, its expected model output is defined as a label, and a difference between actual output of the model and the label is used for determining the performance of the model output or for training of the model.

However, the inventor finds that for a communication system that is actually running, its absolutely correct label signal or label data is often difficult to obtain or requires very large overhead. Therefore, how to obtain a label signal and a label data auxiliary signal with high practicality and low overhead is an urgent problem to be solved.

Embodiments of the present disclosure are described below. Embodiments of the present disclosure may be specifically applied to various scenarios, such as CSI generation and reporting, CSI estimation, beam management, positioning, etc. The following embodiments are described by taking CSI generation and reporting as an example, however the present disclosure is not limited to this.

### Embodiments of a First Aspect

Embodiments of the present disclosure provide a monitoring method of an AI/ML model, the performance of the AI/ML model is monitored by a network device, which is described below from a network device side.

FIG. 2 is a schematic diagram of a monitoring method of an AI/ML model in the embodiments of the present disclosure. As shown in FIG. 2, the method includes:
201, a network device receives an uplink reference signal transmitted by a terminal equipment; and
202, the network device performs performance monitoring on the AI/ML model by using the uplink reference signal.

It should be noted that the above FIG. 2 is only schematic description of the embodiments of the present disclosure, but the present disclosure is not limited to this. For example, an execution order of each operation may be adjusted appropriately, moreover some other operations may be added or one or more operations may be removed. Persons skilled in the art may make appropriate modifications according to the above contents, not limited to the above FIG. 2.

In some embodiments, the AI/ML model is used for generation and reporting of channel state information (CSI), and the AI/ML model includes a CSI generation portion deployed in the terminal equipment and a CSI reconstruction portion deployed in the network device. For example, the CSI generation portion and the CSI reconstruction portion have corresponding model identifiers and/or version identifiers.

FIG. 3 is a schematic diagram of an AI/ML model in the embodiments of the present disclosure. For example, AI/ML may be used for CSI feedbacks to reduce feedback overhead or improve performance. A two-sided model may be used, wherein the CSI generation portion is deployed at a terminal side and the CSI reconstruction portion is deployed at a network side.

After the model is deployed, the performance of model running needs to be monitored, so that a corresponding signal needs to serve as a label signal or assists in generating label data. In addition, in the case of poor performance of model running, small-scale online training and parameter tuning of the model may be carried out, this process is also called fine tuning. Or larger-scale training, online training, model adjustment and update are carried out. In order to further continue to update after model deployment, a label signal or reference signal is also needed to assist in generating a loss function necessary for a training process.

In some embodiments, a network model including a first neural network and a second neural network is provided in the network device, and the network model monitors the AI/ML model; the first neural network being identical to the CSI generation portion of the AI/ML model, and the second neural network being identical to the CSI reconstruction portion of the AI/ML model, or the CSI reconstruction portion of the AI/ML model being taken as the second neural network.

In some embodiments, label data are obtained after the uplink reference signal is inputted into the network model, and the network device compares the label data with output data of the AI/ML model, and performs performance monitoring on the AI/ML model according to a comparison result.

In some embodiments, the uplink reference signal includes at least one of the following: a sounding reference signal (SRS), a positioning sounding reference signal (Positioning SRS), a demodulation reference signal (DMRS), or a positioning reference signal (PRS). The present disclosure is not limited to this. The description is made below by taking the SRS as an example.

In some embodiments, the network device configures the terminal equipment with a CSI-RS for measurement and reporting of the channel state information (CSI) and transmits the same; wherein a bandwidth of the uplink reference signal is identical or similar to a bandwidth of the CSI-RS, or, a bandwidth of the uplink reference signal is larger than a bandwidth of the CSI-RS.

In some embodiments, the network device performs channel estimation on the uplink reference signal according to port information of the CSI-RS to obtain one or more channel coefficients corresponding to the port information of the CSI-RS, and inputs the channel coefficients into the first neural network for use in performance monitoring of the AI/ML model.

FIG. 4 is an example diagram of monitoring by a network device in the embodiments of the present disclosure. As shown in FIG. 4, for a terminal equipment that uses a CSI generation portion with a certain model ID, the network device is not only provided with a CSI reconstruction portion of the model ID (which serves as a second neural network), but also provided with the same CSI generation portion (a first neural network) as the CSI generation portion of the terminal equipment. The network device may monitor performance of this AI/ML model using an uplink RS. A bandwidth of the uplink RS configured by a base station is approximately equal to or greater than a bandwidth of a CSI-RS configured by the base station. A model monitoring process is described below by taking an SRS as an example.

For example, the network device configures the terminal device to transmits an SRS, which may adopt a periodic, semi-periodic, or dynamic scheduling mode. For a certain terminal equipment, a bandwidth of an SRS configured by it is greater than or approximately equal to a bandwidth of a CSI-RS configured by it. For a received SRS signal, the network device may extract the SRS according to a frequency domain density interval of a CSI-RS scheduled by it, perform channel estimation on the SRS received by a receiving antenna corresponding to each port according to the number of CSI-RS ports, and obtain channel coefficients corresponding to the number of ports. In a frequency domain direction, one or more channel coefficients that are consistent with an input dimension of the CSI generation portion may be selected, and the channel coefficients are transmitted to an input end of the CSI generation portion (the first neural network) according to a sequence of transmitting ports.

In some embodiments, in a case where a result of the performance monitoring of the AI/ML model does not satisfy a requirement, the network device notifies one or more terminal equipment in a cell via cell-specific signaling to stop using the AI/ML model. The cell-specific signaling may include a model identifier and/or a version identifier of the AI/ML model.

For example, the first neural network and the second neural network are used at a network side to simulate a situation in which a CSI generation portion of a terminal side and a CSI reconstruction portion of the network side work jointly. As shown in FIG. 4, signal similarity between the input of the CSI generation portion (the first neural network) and the output of the CSI reconstruction portion may be detected, an indicator such as cosine similarity or a mean square error is used. The network side monitors the performance of the model according to this indicator. When the network side determines that the performance of the model cannot satisfy a requirement, the network side notifies terminals in a cell via cell-specific signaling (such as SIB or cell-specific RRC), so that terminals using the model ID stop using the model.

A situation in which a plurality of terminal equipment in a cell use an AI/ML model is schematically described above, a situation in case of one terminal equipment is described below, the same also applies to a plurality of terminal equipment.

In some embodiments, the network device receives terminal side antenna port information reported by the terminal equipment; and the network device performs channel estimation on the uplink reference signal according to the terminal side antenna port information to obtain one or more corresponding channel coefficients, and inputs the channel coefficients into the first neural network for use in performance monitoring of the AI/ML model.

For example, the network device and a certain terminal equipment are respectively provided with a CSI reconstruction portion and a CSI generation portion based on a two-sided model. In order to monitor the performance of the model, the network side is further deployed with a CSI generation portion (a first neural network) corresponding to the model ID, and uses the SRS as a monitoring signal.

The network device may further configure the terminal equipment to report the number of terminal side antenna ports (the number of receiver radio frequency links). The network device refers to terminal side antenna port information to configure the terminal equipment to perform SRS antenna switching.

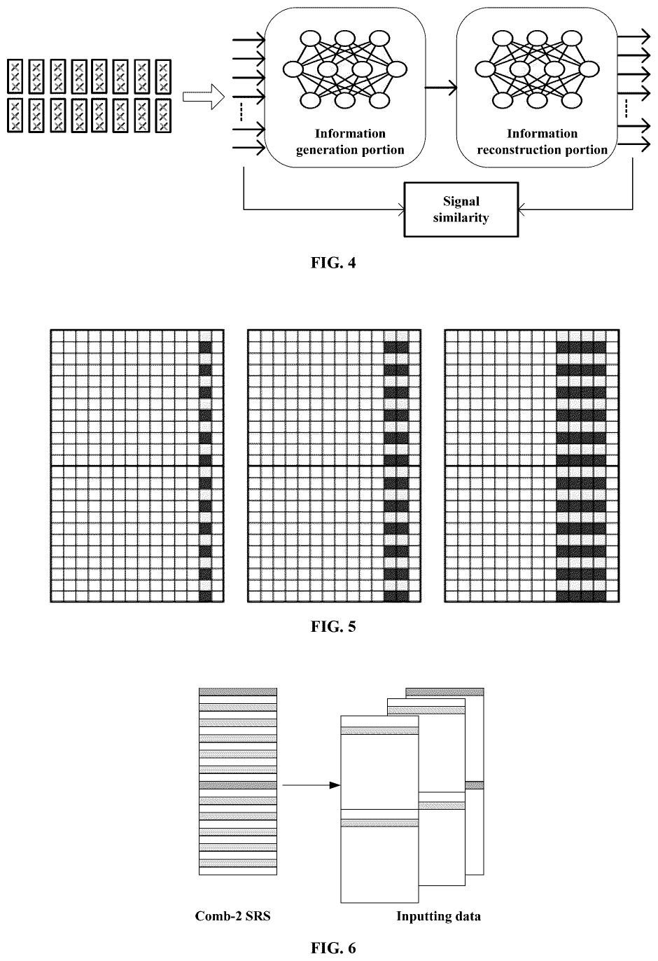

FIG. 5 is a schematic diagram of antenna port switching in the embodiments of the present disclosure. As shown in FIG. 5, situations in case of one receiving port, two receiving ports and four receiving ports are shown respectively. In order to better simulate signal input characteristics of the CSI generation portion of the terminal equipment, for terminal equipment with 1T4R or 2T4R, the network device may configure the terminal equipment to perform corresponding SRS antenna switching.

In some embodiments, in a case where a result of the performance monitoring of the AI/ML model does not satisfy a requirement, the network device notifies the terminal equipment via UE-specific signaling to stop using the AI/ML model, or deactivates CSI reporting of the terminal equipment, or activates non-AI CSI reporting.

For example, the first neural network and the second neural network may be used at a network side to simulate a situation in which a CSI generation portion of a terminal side and a CSI reconstruction portion of the network side work jointly. As shown in FIG. 4, the network device detects signal similarity between the input of the CSI generation portion (the first neural network) and the output of the CSI reconstruction portion, an indicator such as cosine similarity or a mean square error is used. The network side monitors the performance of the model according to this indicator. When the network side determines that the performance of the model cannot satisfy a requirement, the network side deactivates the CSI reporting of the terminal equipment via UE-specific RRC signaling, or a MAC-CE or DCI (if the CSI reporting using the model is in an enabled state), or indicates the terminal equipment to stop using the model.

In some embodiments, the network device extracts an uplink reference signal according to a frequency domain density interval of a CSI-RS.

FIG. 6 is an example diagram of signal extraction in the embodiments of the present disclosure. For example, since a density of an SRS is generally higher than that of a CSI-RS, channel information equal to a CSI-RS interval may be extracted from the SRS. As shown in FIG. 6, data may be extracted from an SRS of comb-2, so that one SRS signal may produce multiple input data samples.

A signaling process of AI/ML model monitoring is described below.

In some embodiments, the network device transmits configuration information and/or indication information to the terminal equipment, so as to schedule the terminal equipment to transmit the uplink reference signal.

In some embodiments, according to a performance monitoring result, the network device further transmits first indication information for indicating to turn on or turn off the AI/ML model, or transmits second indication information for indicating to switch from the AI/ML model to another AI/ML model, to the terminal equipment.

In some embodiments, the network device transmits an AI/ML-related capability query to the terminal equipment; and the network device receives an AI/ML-related capability response fed back by the terminal equipment. The AI/ML-related capability includes at least one of the following: signal processing module information, AI/ML support information, AI/ML model identification information, version information, data configuration information, AI/ML support training capability information, AI/ML upgrade capability information, or performance monitoring capability information.

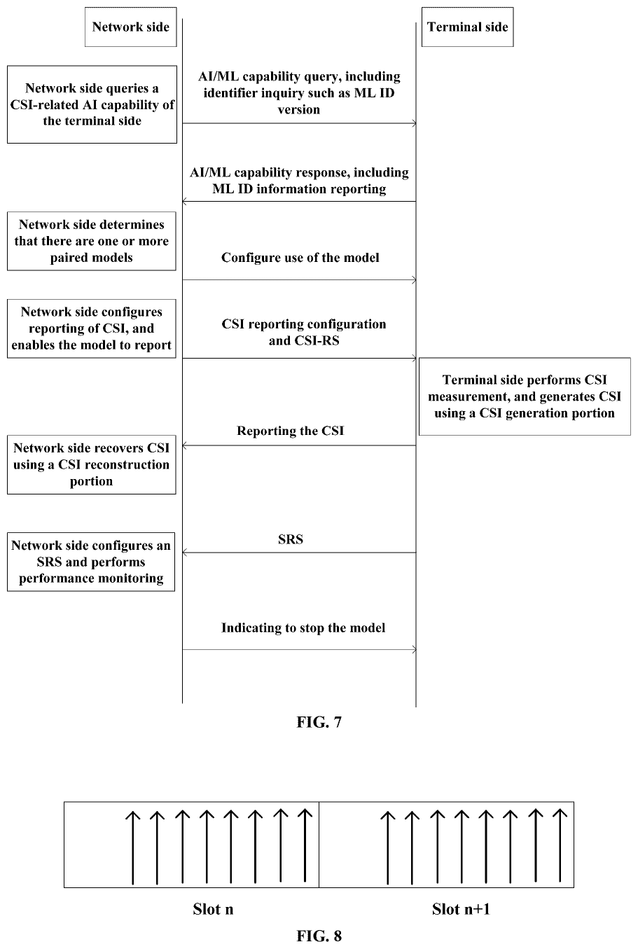

FIG. 7 is an example diagram of signaling for monitoring an AI/ML model in the embodiments of the present disclosure, schematically showing a situation in which a network device performs monitoring and stops a model when the performance is not good.

As shown in FIG. 7, the network side queries the terminal side about CSI-related AI capabilities, such as identification information including ID and version of a CSI generation portion. The terminal side makes a response to AI/ML capabilities, such as including model identification information. After determining that there is a paired model, the network side may configure the model and indicate to use the model.

As shown in FIG. 7, the network side may configure reporting of CSI, and enable the AI/ML model to perform the reporting of CSI. In addition, the network side may transmit a CSI-RS, the terminal side may perform CSI measurement, and perform the reporting of CSI after generating CSI by using the CSI generation portion. The network side reconstruct received CSI by using the CSI reconstruction portion.

As shown in FIG. 7, the network side may further configure the terminal side to transmit the SRS, and the network side performs performance monitoring on the AI/ML model by using the SRS. If the performance does not satisfy a requirement, the network side transmits a model stop indication, indicating the terminal side to stop using the AI/ML model.

It should be noted that the above FIG. 7 is only schematic description of the embodiments of the present disclosure, but the present disclosure is not limited to this. For example, an execution order of each operation may be adjusted appropriately, moreover some other operations may be added or one or more operations may be removed. Persons skilled in the art may make appropriate modifications according to the above contents, not limited to the above FIG. 7.

A situation of stopping a model is schematically described above. For a situation of switching to other AI/ML models or switching to non-AI/ML CSI reporting, adjustments may be made accordingly, there is no detailed description here. Training of an AI/ML model is described below.

In some embodiments, the network device performs training on the AI/ML model by using the uplink reference signal.

For example, in addition to being used for model monitoring, label data may further be used for model retraining, such as fine tuning or online training. Training may be performed by using the uplink reference signal when a model with a model ID determines by monitoring or other modes that further training or parameter optimization needs to be performed.

For example, when an uplink service is not busy, the network device schedules an uplink RS more frequently for model training.

In some embodiments, the network device further transmits reference signal-specific configuration to the terminal equipment, so as to configure the terminal equipment to transmit the uplink reference signal according to the reference signal-specific configuration. The uplink reference signal may be transmitted on consecutive symbols and consecutive slots.

FIG. 8 is an example diagram of a reference signal in embodiments of the present disclosure. As shown in FIG. 8, training-specific SRS configuration may be used, this configuration has more RS symbols and RS RBs in a time-frequency domain. For example, a SRS burst may be supported, i.e., an SRS is transmitted on consecutive symbols and consecutive slots.

In some embodiments, the network device transmits a model update instruction and/or model update information to the terminal equipment in a case where a training result of the AI/ML model satisfies a requirement. The model update information includes at least one of the following: a trained information generation portion, generation portion model update configuration information, generation portion model updating layer number information, generation portion model updating parameter information, a model identifier or a version identifier.

For example, similar to model monitoring, a loss function may be set based on signal similarity, and the loss function may satisfy a performance requirement by using iterative training. When a model has performance that satisfies needs after being trained, verified, and tested, the network side may further configure the terminal side to deactivate or terminate previous SRS training-specific configuration, or legacy high-density SRS configuration.

In some embodiments, the model update information is transmitted via RRC signaling or MAC CE.

For example, after model training is completed, the CSI generation portion of the model is transmitted by the network device to the terminal equipment, and the terminal device is notified to update its CSI generation portion. For fine tuning, during the training process, corresponding to a CSI generation portion, the network device may update only one or several layers of its model network which close to output. For example, a model scale of the CSI generation portion is not large, and may be transmitted to the terminal equipment by means of RRC signaling or MAC CE, which includes updated network layer number information.

In addition, the network device may further determine performance of a stopped model or performance of other models stored in the network device, by constantly monitoring SRS. When it determines that performance of a model with a model ID is good, it may negotiate with the terminal equipment to enable the model.

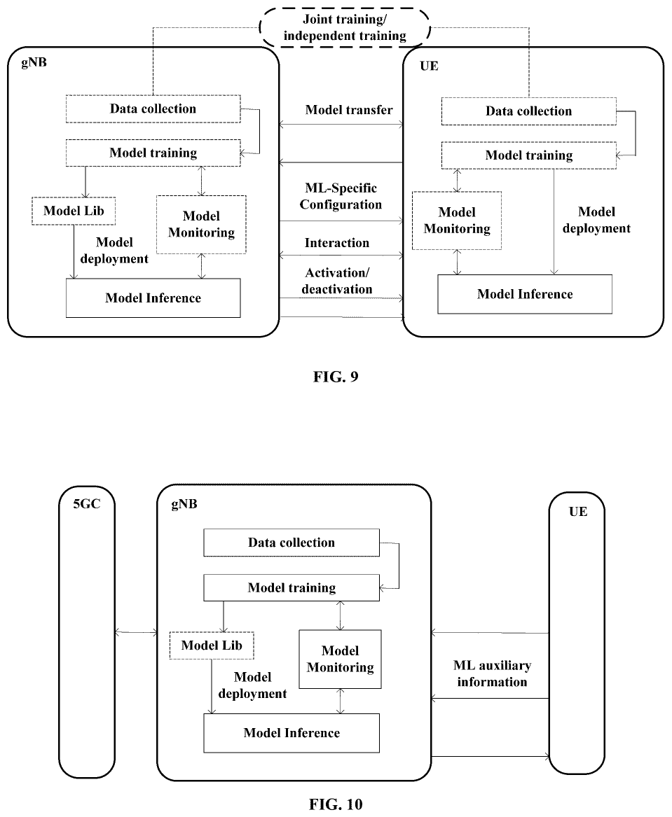

FIG. 9 is a schematic diagram of a two-sided model applied in a gNB and a UE in the embodiments of the present disclosure. As shown in FIG. 9, model monitoring and model training may be implemented at a gNB side or at a UE side, or implemented simultaneously at both of them. The following text describes that model monitoring and/or model training is/are implemented at a gNB side. For a situation in which model monitoring and/or model training is/are implemented at a UE side, refer to the aftermentioned embodiments of the second aspect.

As shown in FIG. 9, the gNB side and the UE side store a set of models corresponding to different channel states. In some embodiments, a gNB may identify a channel state of a UE side, or determines a change in a communication channel via reporting information of the UE side. When monitoring performance is poor, the gNB selects a model for which the gNB thinks its performance is good, and informs an UE to apply a new model.

In order to ensure continuity of communication performance, the gNB may first notify the UE of a new model ID, and after receiving a response that UE reception is successful and the model may be used, the gNB may deactivate a current model used by the UE, and activate a new model.

FIG. 10 is a schematic diagram of a model applied in a gNB in the embodiments of the present disclosure. As shown in FIG. 10, model monitoring and model training may be implemented at the gNB side, the gNB may periodically use a monitoring result and collected data for model training, and transmit relevant information to a core network side.

Scenarios in FIG. 9 and FIG. 10 may be applied not only to generation and reporting of CSI, but also to processing processes such as beam management, positioning, etc.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the above embodiments, the network device receives an uplink reference signal transmitted by the terminal equipment, and the network device performs performance monitoring on the AI/ML model by using the uplink reference signal. Thereby, suitable label data may be obtained at a smaller cost to support monitoring of the AI/ML model.

### Embodiments of a Second Aspect

Embodiments of the present disclosure provide a monitoring method of an AI/ML model, the performance of the AI/ML model is monitored by a terminal equipment. The following description is made from a terminal equipment side, the contents same as the embodiments of the first aspect are not repeated.

FIG. 11 is a schematic diagram of a monitoring method of an AI/ML model in the embodiments of the present disclosure. As shown in FIG. 11, the method includes:
1101, a terminal equipment receives a downlink reference signal transmitted by a network device; and
1102, the terminal equipment performs performance monitoring on the AI/ML model by using the downlink reference signal.

It should be noted that the above FIG. 11 is only schematic description of the embodiments of the present disclosure, but the present disclosure is not limited to this. For example, an execution order of each operation may be adjusted appropriately, moreover some other operations may be added or one or more operations may be removed. Persons skilled in the art may make appropriate modifications according to the above contents, not limited to the above FIG. 11.

In some embodiments, the AI/ML model is used for generation and reporting of channel state information (CSI), and the AI/ML model includes a CSI generation portion deployed in the terminal equipment and a CSI reconstruction portion deployed in the network device. For example, the CSI generation portion and the CSI reconstruction portion have corresponding model identifiers and/or version identifiers.

In some embodiments, a network model including a first neural network and a second neural network is provided in the terminal equipment, and the network model monitors the AI/ML model; the first neural network being identical to the CSI generation portion of the AI/ML model, or the CSI generation portion of the AI/ML model being taken as the first neural network, the second neural network being identical to the CSI reconstruction portion of the AI/ML model.

In some embodiments, label data are obtained after the downlink reference signal is inputted into the network model, and the terminal equipment compares the label data with output data of the AI/ML model, and performs performance monitoring on the AI/ML model according to a comparison result.

In some embodiments, the downlink reference signal is a first channel state information reference signal (CSI-RS) for AI/ML model monitoring and/or training. The terminal equipment receives a second CSI-RS transmitted by the network device and used for measurement of the channel state information (CSI); wherein, a bandwidth of the first CSI-RS is identical to that of the second CSI-RS. The downlink reference signal is not limited to this, for example, it may further be other reference signal.

For example, a terminal equipment has not only a CSI generation portion, but also a CSI reconstruction portion. The terminal equipment may use the CSI-RS as a label signal for model monitoring to determine the performance in model running. For how to specifically determine, relevant technologies may be referred to.

In some embodiments, the terminal equipment receives indication information transmitted by the network device and used for the performance monitoring; the indicator information including a threshold value and/or a count value.

For example, the network side may configure the terminal side with performance metrics and counter indicators for monitoring, or, predefined performance indicators are set; the terminal side counts the number of events that do not satisfy the performance metrics. When a counter or a counting condition satisfies a configuration condition, it is determined that model performance cannot satisfy a requirement. The terminal side requests the network side to stop using the model or deactivate reporting of current CSI.

In some embodiments, the threshold value includes a first threshold value and a second threshold value, and the counter value includes a first counter value and a second counter value; the first threshold value and the first counter value are used to stop the AI/ML model, and the second threshold value and the second counter value are used to start the AI/ML model.

In some embodiments, according to a performance monitoring result, the terminal equipment further transmits third indication information for indicating to turn on or turn off the AI/ML model, or transmits fourth indication information for indicating to switch from the AI/ML model to another AI/ML model, to the network device.

For example, network side configuration uses a legacy mode to perform reporting of CSI (non-AI/ML method). In addition to performing normal measurement and reporting, the terminal side uses a CSI generation portion and a CSI reconstruction portion corresponding to another model ID (including version) to monitor the performance of the model using a CSI-RS. When the performance may reach a configured or predefined indicator, the terminal side transmits a request of using the AI/ML model together with the model ID (version information) to the network side. The network side determines whether to enable the AI/ML model.

In order to better complete the model monitoring, the network side configures the terminal side with relevant model monitoring indication information.

For example, the threshold may include a similarity indicator, such as cosine similarity, generalized cosine similarity, mean square error, etc.

For another example, it simultaneously includes count or timer indicators to determine a model failure based on multiple threshold exceeding events.

For a further example, in order to restart a model or switch a model and avoid a ping-pong effect, a dual performance indication parameter may be configured. For example, a two-sided model runs until it is determined that it should stop, this case is corresponding to a performance indicator of level 1; from a stop state to requesting for running a two-sided model, the case is corresponding to a performance indicator of level 2. Generally, level 2 has a higher performance requirement.

In some embodiments, in a case where a performance monitoring result of the AI/ML model does not satisfy a requirement, the terminal equipment transmits request information for requesting to stop using the AI/ML model or deactivate CSI measurement reporting to the network device, or transmits request information for requesting to switch a model, or transmits request information for activating non-AI CSI reporting.

For example, the request information includes a model identifier and/or a version identifier of the AI/ML model.

A signaling process of AI/ML model monitoring is described below.

In some embodiments, the terminal equipment receives configuration information and/or indication information transmitted by the network device, so as to schedule the terminal equipment to receive the downlink reference signal.

In some embodiments, the terminal equipment receives an AI/ML-related capability query transmitted by the network device; and the terminal equipment feeds back an AI/ML-related capability response to the network device. The AI/ML-related capability includes at least one of the following: signal processing module information, AI/ML support information, AI/ML model identification information, version information, data configuration information, AI/ML support training capability information, AI/ML upgrade capability information, or performance monitoring capability information.

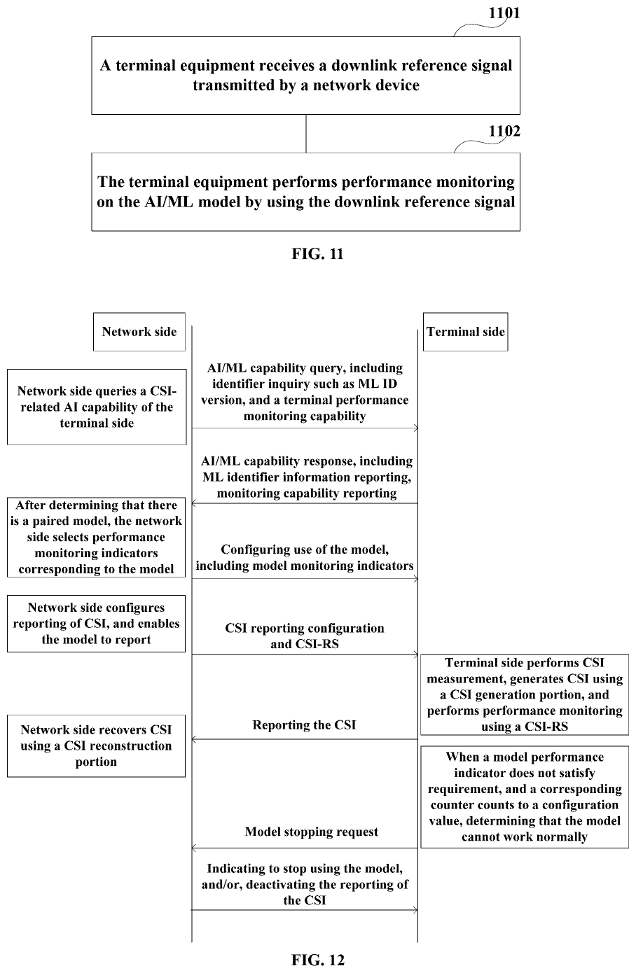

FIG. 12 is an example diagram of signaling for monitoring an AI/ML model in the embodiments of the present disclosure, schematically showing a situation in which a terminal equipment performs monitoring and stops a model when the performance is not good.

As shown in FIG. 12, the network side queries the terminal side about CSI-related AI capabilities, such as identification information including ID and version of a CSI generation portion, and a terminal performance monitoring capability. The terminal side makes a response to AI/ML capabilities, such as including model identification information, and a terminal performance monitoring capability. After determining that there is a paired model, the network side may configure the model and indicate to use the model, and may configure the terminal equipment to perform model monitoring.

As shown in FIG. 12, the network side may configure reporting of CSI, and enable the AI/ML model to perform the reporting of CSI. In addition, the network side may transmit a second CSI-RS, the terminal side may perform CSI measurement, and perform the reporting of CSI after generating CSI by using the CSI generation portion. The network side reconstruct received CSI by using the CSI reconstruction portion.

As shown in FIG. 12, the network side may further configure the terminal side to receive a first CSI-RS, and the terminal side performs performance monitoring on the AI/ML model by using the first CSI-RS. If the performance does not satisfy a requirement, the terminal side determines that the AI/ML model cannot work normally when a corresponding counter counts to a configured value. The terminal side transmits a model stop request, and after receiving the request, the network side may indicate the terminal side to stop using the AI/ML model and/or deactivate reporting of CSI.

It should be noted that the above FIG. 12 is only schematic description of the embodiments of the present disclosure, but the present disclosure is not limited to this. For example, an execution order of each operation may be adjusted appropriately, moreover some other operations may be added or one or more operations may be removed. Persons skilled in the art may make appropriate modifications according to the above contents, not limited to the above FIG. 12.

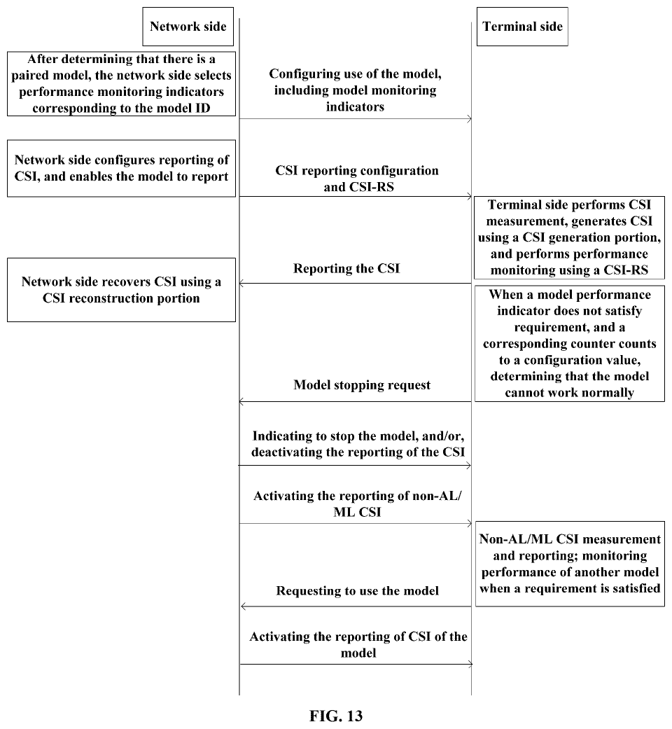

FIG. 13 is another example diagram of signaling for monitoring an AI/ML model in the embodiments of the present disclosure, schematically showing a situation in which a terminal equipment performs monitoring and performs model switching when the performance is not good.

As shown in FIG. 13, after determining that there is a paired model, the network side may configure the model and indicate to use the model, and may configure the terminal equipment to perform model monitoring.

As shown in FIG. 13, the network side may configure reporting of CSI, and enable the AI/ML model to perform the reporting of CSI. In addition, the network side may transmit a second CSI-RS, the terminal side may perform CSI measurement, and perform the reporting of CSI after generating CSI by using the CSI generation portion. The network side reconstruct received CSI by using the CSI reconstruction portion.

As shown in FIG. 13, the network side may further configure the terminal side to receive a first CSI-RS, and the terminal side performs performance monitoring on the AI/ML model by using the first CSI-RS. If the performance does not satisfy a requirement, the terminal side determines that the AI/ML model cannot work normally when a corresponding counter counts to a configured value. The terminal side transmits a model stop request, and after receiving the request, the network side may indicate the terminal side to stop using the AI/ML model and/or deactivate reporting of CSI.

In addition, as shown in FIG. 13, the network side may activate reporting of non-AI/ML CSI, and the terminal side may perform CSI measurement and reporting using a non-AI/ML mode.

Furthermore, the terminal side may monitor the performance of another AI/ML model. When the performance of the AI/ML model satisfies a requirement, the terminal side may transmit a request of enabling the AI/ML model (such as including a model ID), and the network side activates the AI/ML model to perform generation and reporting of CSI.

It should be noted that the above FIG. 13 is only schematic description of the embodiments of the present disclosure, but the present disclosure is not limited to this. For example, an execution order of each operation may be adjusted appropriately, moreover some other operations may be added or one or more operations may be removed. Persons skilled in the art may make appropriate modifications according to the above contents, not limited to the above FIG. 13.

Training of an AI/ML model is described below.

In some embodiments, the terminal equipment performs training on the AI/ML model by using the downlink reference signal.

For example, in addition to being used for model monitoring, label data may further be used for model retraining, such as fine tuning or online training. Training may be performed by using the downlink reference signal when a model with a model ID is determined by monitoring or other modes that further training or parameter optimization needs to be performed.

For example, the network side configures CSI-RS resources and transmits a CSI-RS, but does not need to report CSI information. Or, the network side configures CSI-RS-specific resource configuration for training, the configuration has a CSI-RS with a high time-frequency density.

In some embodiments, the terminal equipment receives reference signal-specific configuration transmitted by the network device, and the terminal equipment receives the downlink reference signal according to the reference signal-specific configuration. For example, the downlink reference signal is transmitted on consecutive symbols and consecutive slots.

For example, the terminal side only uses a CSI-RS for training, or also needs to report configuring a CSI-RS. The CSI-RS configuration is generally periodic or semi-persistent, or, a specific IE is used to indicate that its use is for a training purpose. As shown in FIG. 8, training-specific CSI-RS configuration may be used, this configuration has more RS symbols and RS RBs in a time-frequency domain. For example, that a CSI-RS is transmitted on consecutive symbols and consecutive slots may be supported.

In some embodiments, the terminal equipment transmits a model update request and/or model update information to the network device in a case where a training result of the AI/ML model satisfies a requirement. The model update information includes at least one of the following: a trained information reconstruction portion, reconstruction portion model update configuration information, reconstruction portion model update layer number information, reconstruction portion model update parameter information, a model identifier or a version identifier.

For example, after a model of the terminal equipment is trained, the terminal equipment notifies a base station that the training is completed, and requests to upload a CSI reconstruction portion, a model ID or version information, etc. The network side may stop transmission of the CSI-RS, and configure the terminal equipment to upload model updating information.

For another example, the base station may inform the terminal equipment to use a trained new model ID corresponding to a two-sided model for testing, and transmit a model updating indication to a terminal after the test is completed. For a further example, the network side directly uses a model transmitted by the terminal side to communicate with the terminal, but a model communicated with other terminals is not updated.

In some embodiments, the model update information is transmitted via RRC signaling or MAC CE.

In addition, for fine tuning, during the training process, corresponding to a CSI generation portion and a CSI reconstruction portion, the network device may update only one or several layers of its model network which close to output. Therefore, when the terminal requests model update, layer number information corresponding to an updated model and other parameter information of the updated model may be reported, and the network side thereby configures resources and schedules the terminal to perform updated model uploading.

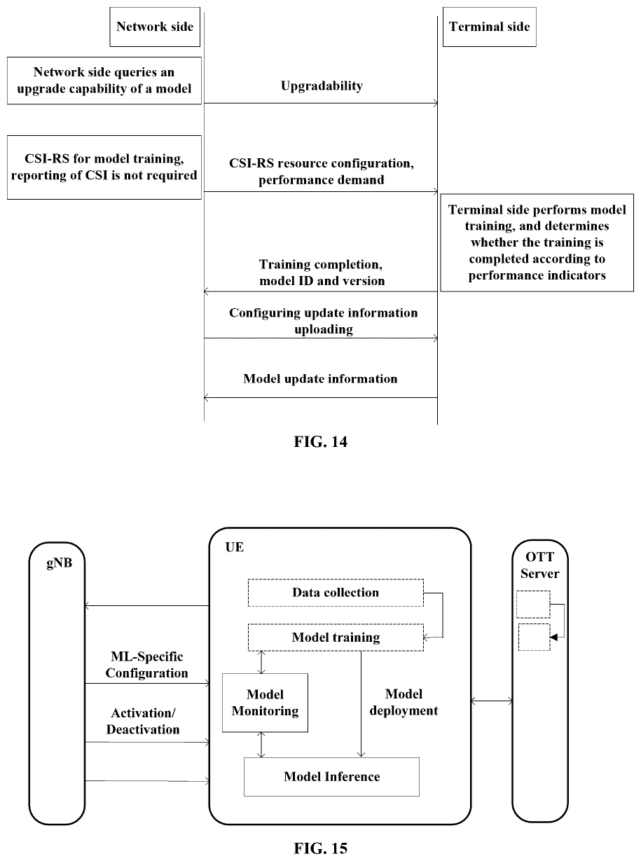

FIG. 14 is an example diagram of performing model training by a terminal equipment in the embodiments of the present disclosure.

As shown in FIG. 14, the network side queries the terminal side about CSI-related AI capabilities, such as identification information including ID and version of a CSI generation portion, and a terminal upgrade capability. The terminal side makes a response to AI/ML capabilities, such as including model identification information, and a terminal upgrade capability. The network side may configure a CSI-RS for training, and indicate that reporting of CSI is not required.

As shown in FIG. 14, the terminal side may perform model training, and determine whether the training is completed according to performance indicators. After the training is completed, the network side may be informed that the training is completed. The network side may configure the terminal side with a resource for uploading model update information, so that the terminal side may upload the model update information.

In some embodiments, FIG. 9 may be referred to, model monitoring and model training may be implemented at a UE side. In the case of terminal side monitoring, when the UE side finds that the monitoring performance is not good, and may determine that a channel state is changed through reception of a CSI-RS, and finds another model that better matches a current channel from its stored models, the UE transmits a request of using a new model to a gNB, and transmits an ID of the model to the gNB.

When the gNB needs to communicate with other terminals using the current model ID, it may reject the request. At this point, the UE may apply to deactivate use of the model according to a monitoring state, and falls back to a non-AI/ML processing mode. It is worth noting that the above model ID may contain version information, and models with different version IDs may be considered as different models.

On the other hand, the UE may transmit monitored data information and/or channel state information via UCI to an eNB according to configuration information of the eNB, as well as channel state information configured by other network device, used for data collection and training of a model.

FIG. 15 is a schematic diagram of a model applied in a UE in the embodiments of the present disclosure. As shown in FIG. 15, model monitoring and model training may be implemented at a UE side. In this situation, a measurement indicator of the model monitoring performance may be configured by the gNB, and the measurement indicator includes, for example, a threshold value of a measurement signal, or a timer or counter value for an abnormal situation.

For example, the UE has a capacity of self-stopping an AI/ML model. When the UE monitors that a corresponding measurement indicator exceeds the above configuration value(s), the terminal automatically stops using the AI/ML model and falls back to a related signal processing mode (non-AI/ML). The terminal itself falls back to a related signal processing mode and reports the stop and fallback behaviors to the eNB.

For another example, the UE does not have a capacity of self-stopping an AI/ML model. When the UE monitors that a corresponding measurement indicator exceeds the above configuration value(s), it has no right to stop a model, it needs to first transmit a request to the gNB, and the gNB deactivates the model.

In addition, according to a state of model monitoring, the terminal side may report state information corresponding to the model ID to an OTT server, and collect measurement information corresponding to a CSI-RS for reporting. The reporting may be transmitted by a data channel, and related configuration needs to be configured by the network side. That is, the network side configures the terminal to periodically transmit its model monitoring information and/or channel state information to the OTT server, which is/are used for the server to collect model-related data and facilitates its training.

Scenarios in FIG. 9 and FIG. 15 may be applied not only to generation and reporting of CSI, but also to processing processes such as beam management, positioning, etc.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the above embodiments, the terminal equipment receives a downlink reference signal transmitted by the network device, and the terminal equipment performs performance monitoring on the AI/ML model by using the downlink reference signal. Thereby, suitable label data may be obtained at a smaller cost to support monitoring of the AI/ML model.

### Embodiments of a Third Aspect

Embodiments of the present disclosure provide a monitoring apparatus of an AI/ML model. The apparatus may be a network device, or may be one or more parts or components configured in the network device. The contents same as the embodiments of the first and second aspect are not repeated.

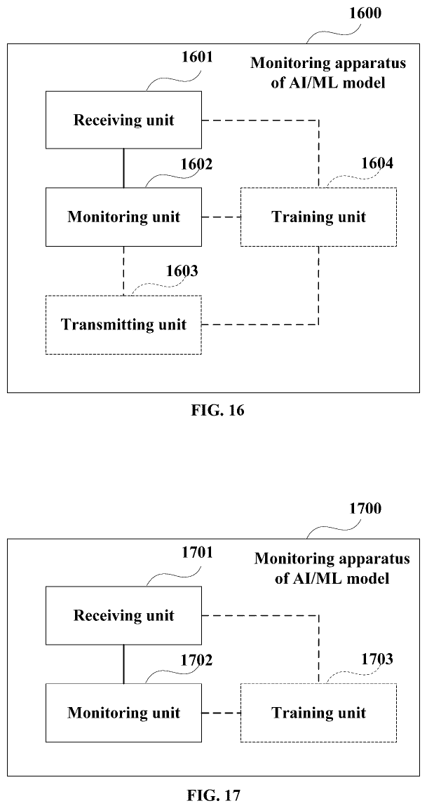

FIG. 16 is a schematic diagram of a monitoring apparatus of an AI/ML model in the embodiments of the present disclosure. As shown in FIG. 16, the monitoring apparatus 1600 of the AI/ML model includes:
a receiving unit 1601 configured to receive an uplink reference signal transmitted by a terminal equipment; and
a monitoring unit 1602 configured to perform performance monitoring on the AI/ML model by using the uplink reference signal.

In some embodiments, as shown in FIG. 16, the monitoring apparatus 1600 of the AI/ML model may further include:
a transmitting unit 1603 configured to transmit configuration information and/or indication information to the terminal equipment, to schedule the terminal equipment to transmit the uplink reference signal.

In some embodiments, according to a performance monitoring result, the transmitting unit 1603 further transmits first indication information for indicating to turn on or turn off the AI/ML model, or transmits second indication information for indicating to switch from the AI/ML model to another AI/ML model, to the terminal equipment.

In some embodiments, the transmitting unit 1603 further transmits an AI/ML-related capability query to the terminal equipment; and the receiving unit 1601 further receives an AI/ML-related capability response fed back by the terminal equipment.

In some embodiments, the AI/ML-related capability includes at least one of the following: signal processing module information, AI/ML support information, AI/ML model identification information, version information, data configuration information, AI/ML support training capability information, AI/ML upgrade capability information, or performance monitoring capability information.

In some embodiments, the AI/ML model is used for generation and reporting of channel state information (CSI), and the AI/ML model includes a CSI generation portion deployed in the terminal equipment and a CSI reconstruction portion deployed in the network device; and
the CSI generation portion and the CSI reconstruction portion have corresponding model identifiers and/or version identifiers.

In some embodiments, the monitoring unit 1602 has a network model which includes a first neural network and a second neural network and monitors the AI/ML model; the first neural network being identical to the CSI generation portion of the AI/ML model, and the second neural network being identical to the CSI reconstruction portion of the AI/ML model, or the CSI reconstruction portion of the AI/ML model being taken as the second neural network.

In some embodiments, label data are obtained after the uplink reference signal is inputted into the network model, and the monitoring unit 1602 compares the label data with output data of the AI/ML model, and performs performance monitoring on the AI/ML model according to a comparison result.

In some embodiments, the uplink reference signal includes at least one of the following: a sounding reference signal (SRS), a positioning sounding reference signal (Positioning SRS), or a demodulation reference signal (DMRS); and
the receiving unit 1601 extracts the uplink reference signal according to a frequency domain density interval of the CSI-RS.

In some embodiments, the network device configures the terminal equipment with a CSI-RS for measurement and reporting of the channel state information (CSI) and transmits the same; and
wherein a bandwidth of the uplink reference signal is identical or similar to a bandwidth of the CSI-RS, or, a bandwidth of the uplink reference signal is larger than a bandwidth of the CSI-RS.

In some embodiments, the monitoring unit 1602 performs channel estimation on the uplink reference signal according to port information of the CSI-RS to obtain a channel coefficient corresponding to the port information of the CSI-RS, and inputs the channel coefficient into the first neural network for use in performance monitoring of the AI/ML model.

In some embodiments, in a case where a result of the performance monitoring of the AI/ML model does not satisfy a requirement, one or more terminal equipment in a cell is/are notified via cell-specific signaling to stop using the AI/ML model; and
wherein the cell-specific signaling includes a model identifier and/or a version identifier of the AI/ML model.

In some embodiments, the monitoring unit 1602 performs channel estimation on the uplink reference signal according to terminal-side antenna port information reported by the terminal equipment to obtain a corresponding channel coefficient, and inputs the channel coefficient into the first neural network for use in performance monitoring of the AI/ML model.

In some embodiments, in a case where a result of the performance monitoring of the AI/ML model does not satisfy a requirement, the terminal equipment is notified via UE-specific signaling to stop using the AI/ML model, or the reporting of the CSI of the terminal equipment is deactivated, or reporting of non-AI CSI is activated.

In some embodiments, as shown in FIG. 16, the apparatus 1600 may further include:
a training unit 1604 configured to train the AI/ML model by using the uplink reference signal.

In some embodiments, the training unit 1604 further transmits reference signal-specific configuration to the terminal equipment, to configure the terminal equipment to transmit the uplink reference signal according to the reference signal-specific configuration; and
wherein the uplink reference signal is transmitted on consecutive symbols and consecutive slots.

In some embodiments, the training unit 1604 transmits a model update instruction and/or model update information to the terminal equipment in a case where a training result of the AI/ML model satisfies a requirement; and
wherein the model update information includes at least one of the following: a trained information generation portion, generation portion model update configuration information, generation portion model update layer number information, generation portion model update parameter information, a model identifier or a version identifier; and
wherein the model update information is transmitted via RRC signaling or MAC CE.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above only describes components or modules related to the present disclosure, but the present disclosure is not limited to this. The monitoring apparatus 1600 of the AI/ML model may further include other components or modules. For detailed contents of these components or modules, relevant technologies may be referred to.

Moreover, for the sake of simplicity, FIG. 16 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

As may be known from the above embodiments, the network device receives an uplink reference signal transmitted by the terminal equipment, and the network device performs performance monitoring on the AI/ML model by using the uplink reference signal. Thereby, suitable label data may be obtained at a smaller cost to support monitoring of the AI/ML model.

### Embodiments of a Fourth Aspect

Embodiments of the present disclosure provide a monitoring apparatus of an AI/ML model. The apparatus may, for example, be a terminal equipment, or it may be one or more parts or components configured on the terminal equipment. The contents same as the embodiments of the first to third aspects are not repeated.

FIG. 17 is a schematic diagram of a monitoring apparatus of an AI/ML model in the embodiments of the present disclosure. As shown in FIG. 17, the monitoring apparatus 1700 of the AI/ML model includes:
a receiving unit 1701 configured to receive a downlink reference signal transmitted by a network device; and
a monitoring unit 1702 configured to perform performance monitoring on the AI/ML model by using the downlink reference signal.

In some embodiments, as shown in FIG. 17, the monitoring apparatus 1700 of the AI/ML model may further include:
a training unit 1703 configured to train the AI/ML model by using the downlink reference signal.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

It's worth noting that the above only describes components or modules related to the present disclosure, but the present disclosure is not limited to this. The monitoring apparatus 1700 of the AI/ML model may further include other components or modules. For detailed contents of these components or modules, relevant technologies may be referred to.

Moreover, for the sake of simplicity, FIG. 17 only exemplarily shows a connection relationship or signal direction between components or modules, however persons skilled in the art should know that various relevant technologies such as bus connection may be used. The above components or modules may be realized by a hardware facility such as a processor, a memory, a transmitter, a receiver, etc. The embodiments of the present disclosure have no limitation to this.

As may be known from the above embodiments, the terminal equipment receives a downlink reference signal transmitted by the network device, and the terminal equipment performs performance monitoring on the AI/ML model by using the downlink reference signal. Thereby, suitable label data may be obtained at a smaller cost to support monitoring of the AI/ML model.

### Embodiments of a Fifth Aspect

The embodiments of the present disclosure further provide a communication system, FIG. 1 may be referred to, the contents same as the embodiments of the first to fourth aspects are not repeated.

In some embodiments, the communication system 100 at least may include:
a terminal equipment configured to receive a downlink reference signal transmitted by a network device, and perform performance monitoring on the AI/ML model by using the downlink reference signal; and/or
the network device configured to receive an uplink reference signal transmitted by the terminal equipment, and perform performance monitoring on the AI/ML model by using the uplink reference signal.

The embodiments of the present disclosure further provide a network device, for example may be a base station, but the present disclosure is not limited to this, it may also be other network device.

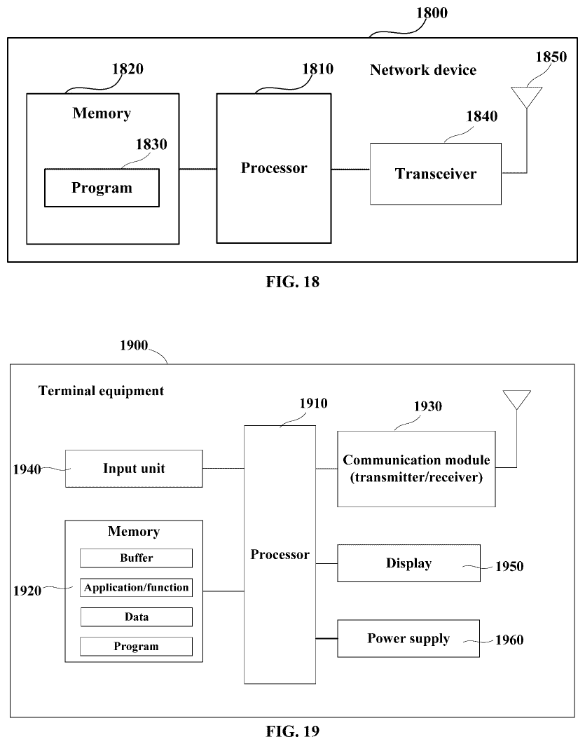

FIG. 18 is a composition schematic diagram of a network device in the embodiments of the present disclosure. As shown in FIG. 18, the network device 1800 may include: a processor 1810 (such as a central processing unit (CPU)) and a memory 1820; the memory 1820 is coupled to the processor 1810. The memory 1820 may store various data; moreover, also stores a program 1830 for information processing, and executes the program 1830 under the control of the processor 1810.

For example, the processor 1810 may be configured to execute a program to implement the monitoring method of the AI/ML model as described in the embodiments of the first aspect. For example, the processor 1810 may be configured to perform the following control: receiving an uplink reference signal transmitted by the terminal equipment, and performing performance monitoring on the AI/ML model by using the uplink reference signal.

In addition, as shown in FIG. 18, the network device 1800 may further include: a transceiver 1840 and an antenna 1850, etc.; wherein the functions of said components are similar to relevant arts, which are not repeated here. It's worth noting that the network device 1800 does not have to include all the components shown in FIG. 18. Moreover, the network device 1800 may further include components not shown in FIG. 18, relevant arts may be referred to.

The embodiments of the present disclosure further provide a terminal equipment, but the present disclosure is not limited to this, it may also be other device.

FIG. 19 is a schematic diagram of a terminal equipment in the embodiments of the present disclosure. As shown in FIG. 19, the terminal equipment 1900 may include a processor 1910 and a memory 1920; the memory 1920 stores data and programs, and is coupled to the processor 1910. It's worth noting that this figure is exemplary; other types of structures can also be used to supplement or replace this structure, so as to realize a telecommunication function or other functions.

For example, the processor 1910 may be configured to execute a program to implement the monitoring method of the AI/ML model as described in the embodiments of the second aspect. For example, the processor 1910 may be configured to perform the following control: receiving a downlink reference signal transmitted by a network device, and performing performance monitoring on the AI/ML model by using the downlink reference signal.

As shown in FIG. 19, the terminal equipment 1900 may further include: a communication module 1930, an input unit 1940, a display 1950 and a power supply 1960. The functions of said components are similar to relevant arts, which are not repeated here. It's worth noting that the terminal equipment 1900 does not have to include all the components shown in FIG. 19, said components are not indispensable. Moreover, the terminal equipment 1900 may further include components not shown in FIG. 19, relevant arts can be referred to.

The embodiments of the present disclosure further provide a computer program, wherein when a terminal equipment executes the program, the program enables the terminal equipment to execute the monitoring method of the AI/ML model described in the embodiments of the second aspect.

The embodiments of the present disclosure further provide a storage medium in which a computer program is stored, wherein the computer program enables a terminal equipment to execute the monitoring method of the AI/ML model described in the embodiments of the second aspect.

The embodiments of the present disclosure further provide a computer program, wherein when a network device executes the program, the program enables the network device to execute the monitoring method of the AI/ML model described in the embodiments of the first aspect.

The embodiments of the present disclosure further provide a storage medium in which a computer program is stored, wherein the computer program enables a network device to execute the monitoring method of the AI/ML model described in the embodiments of the first aspect.

The apparatus and method in the present disclosure may be realized by hardware, or may be realized by combining hardware with software. The present disclosure relates to such a computer readable program, when the program is executed by a logic component, the computer readable program enables the logic component to realize the device described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/device described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipment, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art may make various variations and modifications to the present disclosure according to the spirit and principle of the present disclosure, these variations and modifications are also within the scope of the present disclosure.

As for the implementations including the above embodiments, the following supplements are further disclosed:
1. A monitoring method of an AI/ML model, the performance of the AI/ML model is monitored by a network device, and the method includes:
the network device receives an uplink reference signal transmitted by a terminal equipment; and
the network device performs performance monitoring on the AI/ML model by using the uplink reference signal.
2. The method according to Supplement 1, wherein the method further includes:
the network device transmits configuration information and/or indication information to the terminal equipment, to schedule the terminal equipment to transmit the uplink reference signal.
3. The method according to Supplement 1 or 2, wherein the method further includes:
according to a performance monitoring result, the network device further transmits first indication information for indicating to turn on or turn off the AI/ML model, or transmits second indication information for indicating to switch from the AI/ML model to another AI/ML model, to the terminal equipment.
4. The method according to any one of Supplements 1 to 3, wherein the method further includes:
the network device determines a channel change according to a channel state or the reporting information of the terminal equipment; and
the network device selects another AI/ML model and informs the terminal equipment to use the another AI/ML model.
5. The method according to Supplement 4, wherein the method further includes:
the network device transmits a model identifier and/or a version identifier of the another AIML model to the terminal equipment;
receives response information fed back by the terminal equipment and using the another AI/ML model; and
the network device deactivates a current AI/ML model and activates the another AI/ML model.
6. The method according to any one of Supplements 1 to 5, wherein the method further includes:
the network device transmits a monitoring result and corresponding data of the AI/ML model to a core network.
7. The method according to any one of Supplements 1 to 6, wherein the method further includes:
the network device transmits an AI/ML-related capability query to the terminal equipment; and
the network device receives an AI/ML-related capability response fed back by the terminal equipment.
8. The method according to Supplement 7, wherein the AI/ML-related capability includes at least one of the following: signal processing module information, AI/ML support information, AI/ML model identification information, version information, data configuration information, AI/ML support training capability information, AI/ML upgrade capability information, or performance monitoring capability information.
9. The method according to any one of Supplements 1 to 8, wherein the AI/ML model is used for generation and reporting of channel state information (CSI), and the AI/ML model includes a CSI generation portion deployed in the terminal equipment and a CSI reconstruction portion deployed in the network device.
10. The method according to Supplement 9, wherein a network model including a first neural network and a second neural network and used for monitoring the AI/ML model is provided in the network device; the first neural network being identical to the CSI generation portion of the AI/ML model, and the second neural network being identical to the CSI reconstruction portion of the AI/ML model, or the CSI reconstruction portion of the AI/ML model being taken as the second neural network.
11. The method according to Supplement 10, wherein label data are obtained after the uplink reference signal is inputted into the network model, and the network device compares the label data with output data of the AI/ML model, and performs performance monitoring on the AI/ML model according to a comparison result.
12. The method according to any one of Supplements 9 to 11, wherein the CSI generation portion and the CSI reconstruction portion have corresponding model identifiers and/or version identifiers.
13. The method according to any one of Supplements 9 to 12, wherein the uplink reference signal includes at least one of the following: a sounding reference signal (SRS), a positioning sounding reference signal (Positioning SRS), a demodulation reference signal (DMRS), or a positioning reference signal (PRS).
14. The method according to any one of Supplements 9 to 13, wherein the method further includes:
the network device configures the terminal equipment with a CSI-RS for measurement and reporting of the channel state information (CSI) and transmits the same; and
wherein a bandwidth of the uplink reference signal is identical or similar to a bandwidth of the CSI-RS, or, a bandwidth of the uplink reference signal is larger than a bandwidth of the CSI-RS.
15. The method according to Supplement 14, wherein the method further includes:
the network device extracts the uplink reference signal according to a frequency domain density interval of the CSI-RS.
16. The method according to Supplement 15, wherein
the network device performs channel estimation on the uplink reference signal according to port information of the CSI-RS to obtain a channel coefficient corresponding to the port information of the CSI-RS, and inputs the channel coefficient into the first neural network for use in performance monitoring of the AI/ML model.
17. The method according to Supplement 16, wherein
in a case where a result of the performance monitoring of the AI/ML model does not satisfy a requirement, the network device notifies one or more terminal equipment in a cell via cell-specific signaling to stop using the AI/ML model.
18. The method according to Supplement 17, wherein the cell-specific signaling includes a model identifier and/or a version identifier of the AI/ML model.
19. The method according to Supplement 15, wherein the method further includes:
the network device receives terminal side antenna port information reported by the terminal equipment; and
the network device performs channel estimation on the uplink reference signal according to terminal side antenna port information to obtain a corresponding channel coefficient, and inputs the channel coefficient into the first neural network for use in performance monitoring of the AI/ML model.
20. The method according to Supplement 19, wherein the method further includes:
the network device refers to the terminal side antenna port information to configure the terminal equipment to perform SRS antenna switching.
21. The method according to Supplement 19 or 20, wherein the method further includes:
in a case where a result of the performance monitoring of the AI/ML model does not satisfy a requirement, the network device notifies the terminal equipment via UE-specific signaling to stop using the AI/ML model, or deactivates the reporting of the CSI of the terminal equipment, or activates reporting of non-AI CSI.
22. The method according to any one of Supplements 1 to 21, wherein the method further includes:
the network device performs training on the AI/ML model by using the uplink reference signal.
23. The method according to Supplement 22, wherein
the network device further transmits reference signal-specific configuration to the terminal equipment, so as to configure the terminal equipment to transmit the uplink reference signal according to the reference signal-specific configuration.
24. The method according to Supplement 23, wherein the uplink reference signal is transmitted on consecutive symbols and consecutive slots.
25. The method according to any one of Supplements 22 to 24, wherein the method further includes:
the network device transmits a model update instruction and/or model update information to the terminal equipment in a case where a training result of the AI/ML model satisfies a requirement.
26. The method according to Supplement 25, wherein the model update information includes at least one of the following: a trained information generation portion, generation portion model update configuration information, generation portion model update layer number information, generation portion model update parameter information, a model identifier or a version identifier.
27. The method according to Supplement 25 or 26, wherein the model update information is transmitted via RRC signaling or MAC CE.
28. A monitoring method of an AI/ML model, the performance of the AI/ML model is monitored by a terminal equipment, and the method includes:
the terminal equipment receives a downlink reference signal transmitted by a network device; and
the terminal equipment performs performance monitoring on the AI/ML model by using the downlink reference signal.
29. The method according to Supplement 28, wherein the method further includes:
the terminal equipment receives configuration information and/or indication information transmitted by the network device, to schedule the terminal equipment to receive the downlink reference signal.
30. The method according to Supplement 28 or 29, wherein the method further includes:
according to a performance monitoring result, the terminal equipment further transmits third indication information for indicating to turn on or turn off the AI/ML model, or transmits fourth indication information for indicating to switch from the AI/ML model to another AI/ML model, to the network device.
31. The method according to any one of Supplements 28 to 30, wherein the method further includes:
in a case where the performance of the AI/ML model does not satisfy a requirement, the terminal equipment determines to use another AI/ML model; and
the terminal equipment transmits a request of using the another AI/ML model to the network device; and
in the case of receiving confirmation information transmitted by the network device, the terminal equipment stops a current AI/ML model and starts the another AI/ML model.
32. The method according to Supplement 31, wherein the method further includes:
in the case of receiving reject information transmitted by the network device, the terminal equipment stops a current AI/ML model and falls back to a non-AI/ML mode.
33. The method according to any one of Supplements 28 to 30, wherein the method further includes:
in a case where the performance of the AI/ML model does not satisfy a requirement, the terminal equipment stops using the AI/ML model and falls back to a non-AI/ML mode; and
the terminal equipment transmits information indicating that the AI/ML model has been stopped to the network device.
34. The method according to any one of Supplements 28 to 30, wherein the method further includes:
in a case where the performance of the AI/ML model does not satisfy a requirement, the terminal equipment transmits a request of stopping using the AI/ML model to the network device; and
in the case of receiving confirmation information transmitted by the network device, stops using the AI/ML model and falls back to a non-AI/ML mode.
35. The method according to any one of Supplements 28 to 34, wherein the method further includes:
the terminal equipment transmits model monitoring information and/or channel state information of the AI/ML model to a server or a network device.
36. The method according to Supplement 35, wherein the method further includes:
the terminal equipment receives configuration information and/or indication information transmitted by the network device, so as to upload the model monitoring information and/or channel state information.
37. The method according to any one of Supplements 28 to 36, wherein the method further includes:
the terminal equipment receives an AI/ML-related capability query transmitted by the network device; and
the terminal equipment feeds back an AI/ML-related capability response to the network device.
38. The method according to Supplement 37, wherein the AI/ML-related capability includes at least one of the following: signal processing module information, AI/ML support information, AI/ML model identification information, version information, data configuration information,

AI/ML support training capability information, AI/ML upgrade capability information, or performance monitoring capability information.
39. The method according to any one of Supplements 28 to 38, wherein the method further includes:
the terminal equipment receives indicator information transmitted by the network device and used for the performance monitoring; the indicator information including a threshold value and/or a counter value.
40. The method according to Supplement 39, wherein the threshold value includes a first threshold value and a second threshold value, and the counter value includes a first counter value and a second counter value; the first threshold value and the first counter value are used to stop the AI/ML model, and the second threshold value and the second counter value are used to start the AI/ML model.
41. The method according to any one of Supplements 28 to 40, wherein the AI/ML model is used for generation and reporting of channel state information (CSI), and the AI/ML model includes a CSI generation portion deployed in the terminal equipment and a CSI reconstruction portion deployed in the network device.
42. The method according to Supplement 41, wherein a network model including a first neural network and a second neural network and used for monitoring the AI/ML model is provided in the terminal equipment; the first neural network being identical to the CSI generation portion of the AI/ML model, or the CSI generation portion of the AI/ML model being taken as the first neural network, the second neural network being identical to the CSI reconstruction portion of the AI/ML model.
43. The method according to Supplement 42, wherein label data are obtained after the downlink reference signal is inputted into the network model, and the terminal equipment compares the label data with output data of the AI/ML model, and performs performance monitoring on the AI/ML model according to a comparison result.
44. The method according to any one of Supplements 41 to 43, wherein the CSI generation portion and the CSI reconstruction portion have corresponding model identifiers and/or version identifiers.
45. The method according to any one of Supplements 41 to 44, wherein the downlink reference signal is a first channel state information reference signal (CSI-RS) for AI/ML model monitoring and/or training.
46. The method according to Supplement 45, wherein the method further includes:
the terminal equipment receives a second CSI-RS transmitted by the network device and used for measurement of the channel state information (CSI); wherein, a bandwidth of the first CSI-RS is identical to that of the second CSI-RS.
47. The method according to any one of Supplements 41 to 46, wherein the method further includes:
in a case where a performance monitoring result of the AI/ML model does not satisfy a requirement, the terminal equipment transmits request information for requesting to stop using the AI/ML model or deactivate CSI measurement reporting to the network device, or transmits request information for requesting to switch a model, or transmits request information for activating non-AI CSI reporting.
48. The method according to Supplement 47, wherein the request information includes a model identifier and/or a version identifier of the AI/ML model.
49. The method according to any one of Supplements 41 to 48, wherein the method further includes:
the terminal equipment performs training on the AI/ML model by using the downlink reference signal.
50. The method according to Supplement 49, wherein the method further includes:
the terminal equipment receives reference signal-specific configuration transmitted by the network device; and
the terminal equipment receives the downlink reference signal according to the reference signal-specific configuration.
51. The method according to Supplement 50, wherein the downlink reference signal is transmitted on consecutive symbols and consecutive slots.
52. The method according to any one of Supplements 49 to 51, wherein the method further includes:
the terminal equipment transmits a model update request and/or model update information to the network device in a case where a training result of the AI/ML model satisfies a requirement.
53. The method according to Supplement 52, wherein the model update information includes at least one of the following: a trained information reconstruction portion, reconstruction portion model update configuration information, reconstruction portion model update layer number information, reconstruction portion model update parameter information, a model identifier or a version identifier.
54. The method according to Supplement 52 or 53, wherein the model update information is transmitted via RRC signaling or MAC CE.
55. A network device, including a memory and a processor, the memory storing a computer program, and the processor being configured to execute the computer program to implement the monitoring method of the AI/ML model according to any one of Supplements 1 to 27.
56. A terminal equipment, including a memory and a processor, the memory storing a computer program, and the processor being configured to execute the computer program to implement the monitoring method of the AI/ML model according to any one of Supplements 28 to 54.

What is claimed is:

1. A monitoring apparatus of an AI/ML model, comprising:
a receiver configured to receive an uplink reference signal transmitted by a terminal equipment; and
processor circuitry configured to perform performance monitoring on the AI/ML model by using the uplink reference signal.

2. The apparatus according to claim 1, the apparatus further comprising:
a transmitter configured to transmit configuration information and/or indication information to the terminal equipment, and to schedule the terminal equipment to transmit the uplink reference signal.

3. The apparatus according to claim 2, wherein,
according to a performance monitoring result, the transmitter further transmits first indication information for indicating to turn on or turn off the AI/ML model, or transmits second indication information for indicating to switch from the AI/ML model to another AI/ML model, to the terminal equipment.

4. The apparatus according to claim 2, wherein,
the transmitter further transmits an AI/ML-related capability query to the terminal equipment; and
the receiver further receives an AI/ML-related capability response fed back by the terminal equipment.

5. The apparatus according to claim 4, wherein the AI/ML-related capability comprises at least one of the following: signal processing module information, AI/ML supporting information, AI/ML model identification information, version information, data configuration information, AI/ML support training capability information, AI/ML upgrade capability information, or performance monitoring capability information.

6. The apparatus according to claim 1, wherein the AI/ML model is used for generation and reporting of channel state information, and the AI/ML model comprises a channel state information generation portion deployed in the terminal equipment and a channel state information reconstruction portion deployed in a network device;
the channel state information generation portion and the channel state information reconstruction portion having corresponding model identifiers and/or version identifiers.

7. The apparatus according to claim 6, the apparatus comprising a network model including a first neural network and a second neural network and used for monitoring the AI/ML model, the first neural network being identical to the channel state information generation portion of the AI/ML model, and the second neural network being identical to the channel state information reconstruction portion of the AI/ML model, or the channel state information reconstruction portion of the AI/ML model being taken as the second neural network.

8. The apparatus according to claim 7, wherein label data are obtained after the uplink reference signal is inputted into the network model, and the processor circuitry compares the label data with output data of the AI/ML model, and performs performance monitoring on the AI/ML model according to a comparison result.

9. The apparatus according to claim 6, wherein the uplink reference signal comprises at least one of the following: a sounding reference signal, a positioning sounding reference signal, or a demodulation reference signal; and
the receiver extracts the uplink reference signal according to a frequency domain density interval of a channel state information reference signal.

10. The apparatus according to claim 6, wherein the network device configures the terminal equipment with a channel state information reference signal for measurement and reporting of the channel state information and transmits the same;
wherein a bandwidth of the uplink reference signal is identical or similar to a bandwidth of the channel state information reference signal, or, a bandwidth of the uplink reference signal is larger than a bandwidth of the channel state information reference signal.

11. The apparatus according to claim 6, wherein,
the processor circuitry performs channel estimation on the uplink reference signal according to port information of the channel state information reference signal to obtain a channel coefficient corresponding to the port information of the channel state information reference signal, and inputs the channel coefficient into the first neural network for use in performance monitoring of the AI/ML model.

12. The apparatus according to claim 11, wherein in a case where a result of the performance monitoring of the AI/ML model does not satisfy a requirement, one or more terminal equipment in a cell is/are notified via cell-specific signaling to stop using the AI/ML model;
wherein the cell-specific signaling comprises a model identifier and/or a version identifier of the AI/ML model.

13. The apparatus according to claim 6, wherein,
the processor circuitry performs channel estimation on the uplink reference signal according to terminal-side antenna port information reported by the terminal equipment to obtain a corresponding channel coefficient, and inputs the channel coefficient into the first neural network for use in performance monitoring of the AI/ML model.

14. The apparatus according to claim 13, wherein in a case where a result of the performance monitoring of the AI/ML model does not satisfy a requirement, the terminal equipment is notified via UE-specific signaling to stop using the AI/ML model, or the reporting of the channel state information of the terminal equipment is deactivated, or reporting of non-AI/ML channel state information is activated.

15. The apparatus according to claim 1, wherein
the processor circuitry is further configured to train the AI/ML model by using the uplink reference signal.

16. The apparatus according to claim 15, the apparatus further comprising:
a transmitter configured to transmit reference signal-specific configuration to the terminal equipment, so as to configure the terminal equipment to transmit the uplink reference signal according to the reference signal-specific configuration;
wherein, the uplink reference signal is transmitted on consecutive symbols and consecutive slots.

17. The apparatus according to claim 15, the apparatus further comprising:
a transmitter configured to transmit a model update instruction and/or model update information to the terminal equipment in a case where a training result of the AI/ML model satisfies a requirement;
wherein the model update information comprises at least one of the following: a trained information generation portion, generation portion model update configuration information, generation portion model update layer number information, generation portion model update parameter information, a model identifier or a version identifier; and
wherein the model update information is transmitted via radio resource control signaling or media access control (MAC) control element.

18. A monitoring apparatus of an AI/ML model, the apparatus comprising:
a receiver configured to receive a downlink reference signal transmitted by a network device; and
processor circuitry configured to perform performance monitoring on the AI/ML model by using the downlink reference signal.

19. The apparatus according to claim 18, wherein
the processor circuitry is further configured to train the AI/ML model by using the downlink reference signal.

20. A communication system, comprising:
a terminal equipment configured to receive a downlink reference signal transmitted by a network device, and perform performance monitoring on the AI/ML model by using the downlink reference signal; and/or
the network device configured to receive an uplink reference signal transmitted by the terminal equipment, and perform performance monitoring on the AI/ML model by using the uplink reference signal.
